(19) United States
(12) Patent Application Publication
(10) Pub. No.: US 2003/0198828 A1
(43) Pub. Date: Oct. 23, 2003

(54) Flexible circuit substrate

(76) Inventors: Tang-Chieh Huang, Tainan Hsien (TW); Chau-Chin Chuang, Kaohsiung City (TW)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/444,976

(22) Filed: May 27, 2003

Related U.S. Application Data
(63) Continuation-in-part of application No. 10/022,267, filed on Dec. 20, 2001, now abandoned.

(30) Foreign Application Priority Data
Jul. 17, 2001 (TW) 090117468

(51) Int. Cl. B32B 15/08

(52) U.S. Cl. 428/626

(57) ABSTRACT

A flexible circuit substrate includes a laminate which contains a polymer film, a VIB group metal layer sputtered on the polymer film, a nickel-chromium alloy layer sputtered on the VIB group metal layer, and a copper layer formed on the nickel-chromium alloy layer. The VIB group metal layer is selected from the group consisting of chromium, molybdenum, and tungsten. The VIB group metal layer is free of metal oxide. The VIB group metal layer and the nickel-chromium alloy layer are formed by a sputtering process using an oxygen-free inert atmosphere containing argon.

### CROSS-REFERENCE TO RELATED APPLICATION

This application is a continuation-in-part of U.S. patent application Ser. No. 10/022,267, filed on Dec. 20, 2001, and abandoned as of the filing date of this application.

### BACKGROUND OF THE INVENTION

1. Field of the Invention

The invention relates to a flexible circuit substrate, more particularly to a flexible circuit substrate having an improved peel strength.

2. Description of the Related Art

Conventional flexible circuit substrates are essentially classified into two categories, i.e., one containing an adhesive layer and one free of an adhesive layer. The process for manufacturing the flexible circuit substrate containing the adhesive layer includes the steps of applying an adhesive layer onto a layer of polymer material, such as polyimide or polyester, and adhering a copper layer formed by calendering onto the adhesive layer so as to form a three-layer laminate. The adhesive layer has a thickness ranging from 12.5 μm to 25 μm, and is made of acrylate or epoxy resin. Since the flexible circuit substrate useful for supporting electronic elements thereon is usually processed at high temperatures, this type of flexible circuit substrate is susceptible to delaminating and bubbling.

The process for manufacturing the flexible circuit substrate free of an adhesive layer includes the steps of directly applying a liquid polymer layer onto a copper layer formed by calendering, and drying the liquid polymer layer to form a polymer film on the copper layer. However, the adhesion between the polymer film and the copper layer is relatively poor.

Moreover, since the calendering thickness of the copper layer for calendering in the aforesaid flexible circuit substrates is limited, it is difficult to produce a compact circuit by etching the flexible circuit substrate. Therefore, a manufacturing process including sputtering and plating techniques has been developed heretofore to produce a flexible circuit substrate. Referring to FIG. 1, the manufacturing process includes the steps of sputtering a chromium layer 12 on a polymer layer 11, sputtering a first copper layer 13 on the chromium layer 12, and plating a second copper layer 14 on the first copper layer 13. The thickness of the chromium layer 12 and the first copper layer 13 can be smaller than 1 μm. The polymer layer 11 is made of polyimide, polyester or other plastics resistant to high temperature. The typical thickness of the product manufactured from this process is about 25-50 μm.

In the laminate of the flexible circuit substrate shown in FIG. 1, the chromium layer 12 is interposed between the polymer layer 11 and the first copper layer 13. Since the adhesion between the chromium layer 12 and the polymer layer 11 is superior to that between the first copper layer 13 and the polymer layer 11, and since the adhesion between the chromium layer 12 and the first copper layer 13 is superior to that between the first copper layer 13 and the polymer layer 11, the polymer layer 11, the chromium layer 12, the first copper layer 13, and the second copper layer 14 are laminated in sequence to form the laminate shown in FIG. 1. In addition to improvements in the characteristics, such as thermal resistance, light weight and circuit density, the overall peel strength of the flexible circuit substrate shown in FIG. 1 is also increased by strengthening the bonding between the adjacent layers in the laminate of the flexible circuit substrate. The 90° peel strength of the flexible circuit substrate of FIG. 1 is about 0.5 kgf/cm.

Additionally, the same effects can be achieved by substituting the chromium layer 12 with a nickel alloy (such as nickel-chromium alloy) layer.

Furthermore, U.S. Pat. No. 4,917,963 discloses an assembly comprising a substrate (such as, polymer), a graded composition primer layer, and a conductor. The graded composition primer layer includes a first metal and a second metal different from the first metal, and having a composition continuously varying from a predominance of the first metal at the surface facing away from the substrate to a predominance of the second metal at the surface bonded to the substrate. The conductor is made of the first metal. This patent merely suggests that the primer layer intermediate the substrate and the conductor be a single layer which continuously varies in composition between two opposite surfaces thereof.

U.S. Pat. No. 6,060,175 discloses a metal-film laminate, which comprises (a) a polyimide film having at least one surface bearing a non-continuous random distribution of metal-oxide, and (b) a metal surface including a first metal layer having a chromium metal composition, a second metal layer formed on the first metal layer, and a third metal layer formed on the second layer. This patent further discloses that the metal oxide layer may be produced via a film treatment using a chromium electrode and an oxygen plasma. The first metal layer may include an alloy of nickel and chromium, and the second and third layers may be copper. While the metal-film laminate disclosed in this patent can exhibit a high peel strength greater than 3 lbs/in, the laminate requires a sputtered metal oxide layer which must be produced by a reactive sputtering process using an oxygen plasma. The reactive sputtering process requires a high level of skill for control of the process, thereby complicating the manufacturing of the metal-film laminate.

### SUMMARY OF THE INVENTION

Therefore, the object of the present invention is to provide a flexible circuit substrate made of a metal-film laminate which has a high peel strength, and which can be produced without using a sputtered metal oxide layer.

A flexible circuit substrate according to this invention includes a laminate which contains a polymer film, a VIB group metal layer sputtered on the polymer film, a nickel-chromium alloy layer sputtered on the VIB group metal layer, and a copper layer formed on the nickel-chromium alloy layer. The VIB group metal layer is selected from the group consisting of chromium, molybdenum, and tungsten. The VIB group metal layer is free of metal oxide. The VIB group metal layer and the nickel-chromium alloy layer are formed by a sputtering process using an oxygen-free inert atmosphere containing argon.

The inventors of the present invention discovered that, when a laminate including an oxide-free VIB group metal layer and a layer of nickel-chromium alloy are formed between a polymer film substrate and a conductor layer, the laminate can exhibit a high peel strength of at least 1.0 kgf/cm. Since the oxide-free metal layer can be formed by a sputtering process using an inert atmosphere which can be carried out more easily than the oxygen plasma sputtering process, the manufacturing of the laminate according to the present invention can be facilitated.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view of a conventional flexible circuit substrate;

FIG. 2 is a sectional view of the first preferred embodiment of the flexible circuit substrate according to this invention;

FIG. 3 is a flow diagram of a process for manufacturing the preferred embodiment of FIG. 2;

FIG. 4 is a sectional view of the third preferred embodiment of the flexible circuit substrate according to this invention;

FIG. 5 is a flow diagram of a process for manufacturing the preferred embodiment of FIG. 4;

FIG. 6 is a sectional view of the fourth preferred embodiment of the flexible circuit substrate according to this invention; and

FIG. 7 is a flow diagram of a process for manufacturing the preferred embodiment of FIG. 6.

### DETAILED DESCRIPTION OF THE PREFERRED EMBODIMENTS

Referring to FIG. 2, the first preferred embodiment of the flexible circuit substrate according to this invention is shown to include a polyimide film 21, a chromium layer 22 sputtered on the polyimide film 21, a nickel-chromium alloy layer 23 sputtered on the chromium layer 22, a first copper layer 24 sputtered on the nickel-chromium alloy layer 23, and a second copper layer 25 plated on the first copper layer 24.

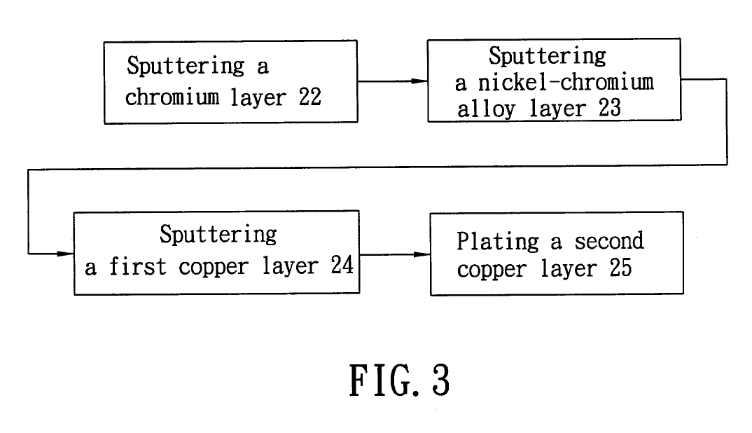

Referring to FIG. 3 and Table 1, the process for manufacturing the first preferred embodiment of FIG. 2 includes the following steps:

(1) The chromium layer 22 is sputtered on the polyimide film 21. The polyimide film 21 is a square film that is 10 cm×10 cm in size. The chromium material for the sputtering step is a square material that is 20 cm×20 cm in size. The sputtering is performed for 1 minute in an argon atmosphere. The electric current applied during the sputtering step is 1.0 A. The pressure of the sputtering gas is 5×10⁻³ torr. The flow of the sputtering gas is 2×10⁻³ torr. The distance between the polyimide film 21 and the chromium material for the sputtering step is 20 cm. The thus-formed chromium layer 22 has a thickness smaller than 1 μm.

(2) The nickel-chromium alloy layer 23 is sputtered on the chromium layer 22 in an argon atmosphere. The operating conditions for performing the sputtering process are identical to those used in the former step except that the material for the sputtering process is nickel-chromium alloy. The thus-formed nickel-chromium layer 23 has a thickness smaller than 1 μm.

(3) The first copper layer 24 is sputtered on the nickel-chromium alloy layer 23 in an argon atmosphere. The material used for this sputtering process is copper. The thus-formed copper layer 24 has a thickness smaller than 1 μm.

(4) The second copper layer 25 is plated on the first copper layer 24. The material used for this plating step is copper. The plating step is performed for 1 hour with an electric current of 0.5 A. The thus-formed copper layer 25 has a thickness of about 18 μm.

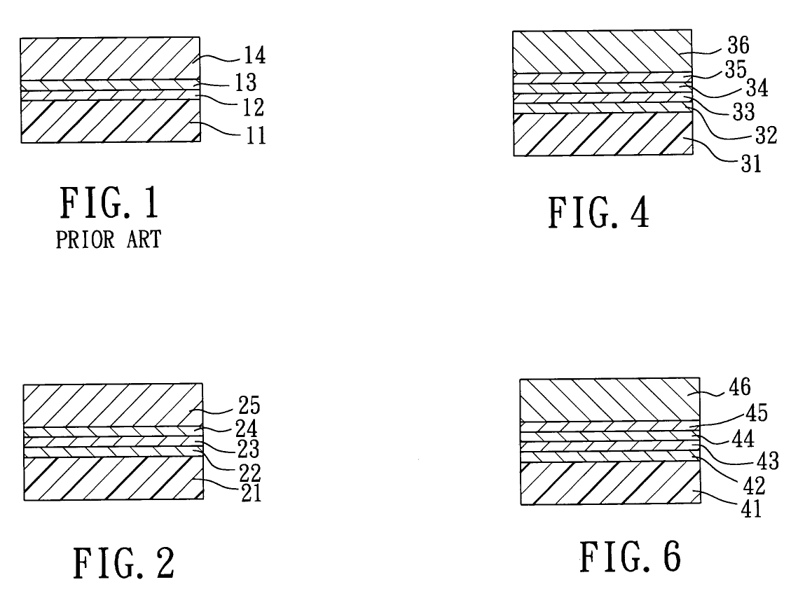

The expansion coefficients of chromium, nickel and copper are 6.5×10⁻⁶, 13.3×10⁻⁶, and 17.0×10⁻⁶, respectively. The expansion coefficient of the nickel-chromium alloy should be between 6.5×10⁻⁶ and 13.3×10⁻⁶. In the laminate of the first preferred embodiment shown in FIG. 2, it is therefore apparent that the nickel-chromium alloy layer 23 has an expansion coefficient greater than that of the chromium layer 22 and smaller than that of the first copper layer 24. The expansion coefficient gradients between adjacent layers of the laminate of this preferred embodiment are reduced as compared to those of the conventional flexible circuit substrate shown in FIG. 1. Therefore, the 90° peel strength of the laminate of this preferred embodiment is improved. According to a test conducted for the 90° peel strength, the 90° peel strength of the conventional flexible circuit substrate shown in FIG. 1 is 0.5 kgf/cm, whereas the 90° peel strength of the first preferred embodiment shown in FIG. 2 is greater than 1.0 kgf/cm, which is higher than that of the prior art.

Referring to Table 1, in the second preferred embodiment, the operating conditions are identical to those used in the first preferred embodiment, except that the polyimide film is substituted with a polyester, such as PET. The thus-formed flexible circuit substrate also has a 90° peel strength of at least 1.0 kgf/cm.

Referring to FIG. 4, the third preferred embodiment of the flexible circuit substrate according to this invention is shown to include a polyimide film 31, a chromium layer 32 sputtered on the polyimide film 31, a nickel-chromium alloy layer 33 sputtered on the chromium layer 32, a nickel layer 34 sputtered on the nickel-chromium alloy layer 33, a first copper layer 35 sputtered on the nickel layer 34, and a second copper layer 36 plated on the first copper layer 35.

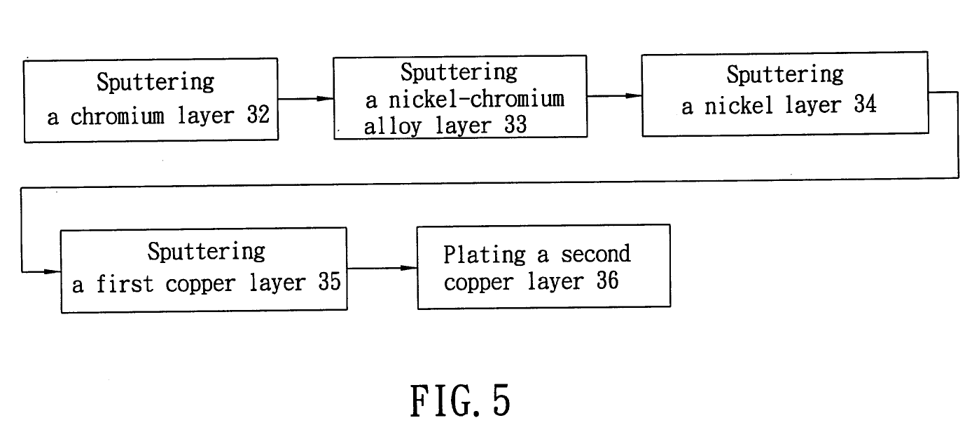

Referring to FIG. 5, the process for manufacturing the third preferred embodiment includes the steps of sputtering the chromium layer 32, the nickel-chromium alloy layer 33, the nickel layer 34, and the first copper layer 35 in sequence, and the step of plating the second copper layer 36. The relevant operating conditions for the sputtering process are identical to those applied in the manufacture of the first preferred embodiment, and the relevant operating conditions for the plating step are identical to those of the plating step in the manufacture of the first preferred embodiment.

Since the expansion coefficient of nickel is between those of nickel-chromium alloy and copper, the expansion coefficient gradient between the adjacent layers of this preferred embodiment can be further reduced. According to the 90° peel strength test, the 90° peel strength of this preferred embodiment is greater than 1.0 kgf/cm.

Referring to FIG. 6, the fourth preferred embodiment of the flexible circuit substrate according to this invention is shown to include a polyimide film 41, a molybdenum layer 42 sputtered on the polyimide film 41, a nickel-chromium alloy layer 43 sputtered on the molybdenum layer 42, a gold layer 44 sputtered on the nickel-chromium alloy layer 43, a first copper layer 45 sputtered on the gold layer 44, and a second copper layer 46 plated on the first copper layer 45.

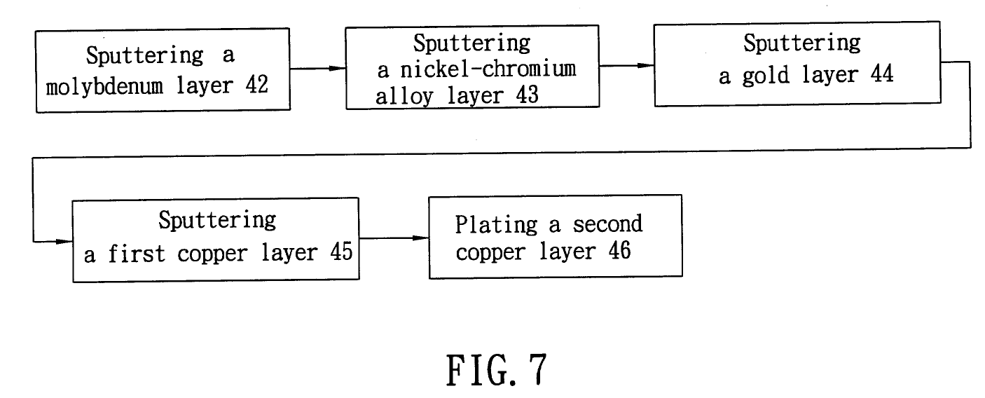

Referring to FIG. 7, in the process for manufacturing the fourth preferred embodiment, the process of FIG. 5 is repeated except that molybdenum material for the molybdenum layer 42 and gold material for the gold layer 44 (see FIG. 6) are substituted for chromium material for the chromium layer 32 and nickel material for the nickel layer 34 (See FIG. 4), respectively. According to the 90° peel strength test, the 90° peel strength of the fourth embodiment is also greater than 1.0 kgf/cm.

Referring to Table 1, the fifth preferred embodiment of the flexible circuit substrate of this invention is identical to the first preferred embodiment, except that the sputtering process is performed for 2 minutes with an electric current of 0.5 A. According to the 90° peel strength test, the 90° peel strength of the fifth preferred embodiment is also greater than 1.0 kgf/cm.

The sixth preferred embodiment of the flexible circuit substrate of this invention is identical to the first preferred embodiment, except that the pressure of sputtering gas is 5×10⁻⁴ torr and that the flow of sputtering gas is 8×10⁻⁵ torr. According to the 90° peel strength test, the 90° peel strength of the sixth preferred embodiment is also greater than 1.0 kgf/cm.

The seventh preferred embodiment of the flexible circuit substrate of this invention is identical to the first preferred embodiment, except that the plating is performed for 0.5 hour with an electric current of 1.0 A. According to the 90° peel strength test, the 90 peel strength of this embodiment is also greater than 1.0 kgf/cm.

Moreover, when tungsten, which has an expansion coefficient of 4.5×10⁻⁶, is used for the VIB group metal of the flexible circuit substrate of this invention, the 90° peel strength of the flexible circuit substrate is also at least 1.0 kgf/cm.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

TABLE 1

| Ex. | 1 | 2 | 3 | 4 | 5 | 6 | 7 |
|---|---|---|---|---|---|---|---|
| Size of polymer | 10 cm × 10 cm | | | | | | |
| film | | | | | | | |
| Size of | 20 cm × 20 cm | | | | | | |
| sputtering/ | | | | | | | |
| plating | | | | | | | |
| material | | | | | | | |
| distance | 20 cm | | | | | | |
| Polymer | PI | PE | PI | PI | PI | PI | PI |

Sputtering in an argon atmosphere

| | | | | | | | |
|---|---|---|---|---|---|---|---|
| #1 | Cr | Cr | Cr | Mo | Cr | Cr | Cr |
| (time) | (1 min) | (1 min) | (1 min) | (1 min) | (2 min) | (1 min) | (1 min) |
| #2 | Ni—Cr | Ni—Cr | Ni—Cr | Ni—Cr | Ni—Cr | Ni—Cr | Ni—Cr |
| (time) | (1 min) | (1 min) | (1 min) | (1 min) | (2 min) | (1 min) | (1 min) |
| #3 | Cu | Cu | Ni | Au | Cu | Cu | Cu |
| (time) | (1 min) | (1 min) | (1 min) | (1 min) | (2 min) | (1 min) | (1 min) |
| #4 | — | — | Cu | Cu | — | — | — |
| (time) | | | (1 min) | (1 min) | | | |
| Current | 1.0 | 1.0 | 1.0 | 1.0 | 0.5 | 1.0 | 1.0 |
| (A) | | | | | | | |
| Pressure | 5 × 10⁻³ | 5 × 10⁻³ | 5 × 10⁻³ | 5 × 10⁻³ | 5 × 10⁻³ | 5 × 10⁻⁴ | 5 × 10⁻³ |
| (torr) | | | | | | | |

Plating

| material | Copper | |
|---|---|---|
| thickness | 18 μm | |
| Current | 0.5 A | 1.0 A |
| (Time) | (1 hr) | (0.5 hr) |

| | |
|---|---|
| 90° Peel | >1.0 kgf/cm |
| strength | |

PE: Polyester
PI: Polyimide

We claim:

1. A flexible circuit substrate, comprising a laminate which includes:
a polymer film;
a VIB group metal layer sputtered on said polymer film;
a nickel-chromium alloy layer sputtered on said VIB group metal layer; and
a first copper layer formed on said nickel-chromium alloy layer;
wherein said VIB group metal layer is selected from the group consisting of chromium, molybdenum, and tungsten, said VIB group metal layer being free of metal oxide, said VIB group metal layer and said nickel-chromium alloy layer being formed by a sputtering process using an oxygen-free inert atmosphere containing argon.

2. The flexible circuit substrate as claimed in claim 1, further comprising a second copper layer plated on said first copper layer.

3. The flexible circuit substrate as claimed in claim 1, wherein said laminate further includes a nickel layer formed between said nickel-chromium alloy layer and said first copper layer.

4. The flexible circuit substrate as claimed in claim 1, wherein said laminate further includes a gold layer formed between said nickel-chromium alloy layer and first copper layer.

5. The flexible circuit substrate as claimed in claim 1, wherein said polymer film is selected from the group consisting of polyimide film and polyester film.
